(19) United States
(12) Patent Application Publication
(10) Pub. No.: US 2018/0328395 A1
(43) Pub. Date: Nov. 15, 2018

(54) Slide-in fastener for use in cabinet assembly

(71) Applicant: David Oliver Boone, Chesapeake, VA (US)

(72) Inventor: David Oliver Boone, Chesapeake, VA (US)

(21) Appl. No.: 15/955,340

(22) Filed: Apr. 17, 2018

Related U.S. Application Data
(60) Provisional application No. 62/505,893, filed on May 13, 2017.
(60) Provisional application No. 62/504,708, filed on May 11, 2017.

(51) Int. Cl. F16B 12/22; F16B 12/36

(52) U.S. Cl. CPC F16B 12/22; A47B 2230/0074; A47B 2230/0033; F16B 12/36

(57) ABSTRACT

A system for slide-in fastening includes a first furniture member including slide-in dowels, each including a cut-out surface, an entry cut, a rear cut; a second furniture member with slide-in apertures, each including an entry opening and interior, and a target opening and interior, such that the dowels insert into entry interiors and slide sideways into the target interiors to hold the first and second furniture members securely together. Also disclosed are a method of manufacturing a slide-in dowel, including inserting the slide-in dowel, and machining an exposed front cut-out; and a method of manufacturing a slide-in dowel, including inserting, moving horizontally, and extracting a slide-in drill bit.

### CROSS-REFERENCE TO RELATED APPLICATIONS

This U.S. Non-Provisional Application claims the benefit of U.S. Provisional Application No. 62/505,893, filed May 13, 2017, and of U.S. Provisional Application No. 62/504,708, filed May 11, 2017; all of which are hereby included herein by reference in their entirety.

### FIELD OF THE INVENTION

The present invention relates generally to the field of cabinet and furniture construction, and more particularly to fastening devices, methods and systems for use in cabinet and furniture assembly.

### BACKGROUND OF THE INVENTION

Traditionally, some cabinets are assembled using dowels and glue, in a time consuming and expensive process that is not suitable for do-it-yourself users. Other modern manufacturing methods rely on cam connectors that, although simple in use, do not produce a stable fastening function, and generally will loosen significantly after shipping, disassembly, and reassembly. Other modern connectors may function well, but are complex and time consuming to manufacture.

As such, considering the foregoing, it may be appreciated that there continues to be a need for novel and improved devices and methods for fastening devices, methods and systems for use in cabinet and furniture assembly.

### SUMMARY OF THE INVENTION

The foregoing needs are met, to a great extent, by the present invention, wherein in aspects of this invention, enhancements are provided to the existing model of fastening systems and devices for assembly of cabinets and other furniture.

In an aspect, a system for slide-in fastening can include:
a) A first furniture member, which can be a first cabinet piece, such as a horizontal cabinet top/bottom, wherein the first furniture member comprises:
   a plurality of slide-in dowels protruding from an end of the first furniture member; and
b) A second furniture member, which can be a second cabinet piece, such as a vertical cabinet side, wherein the second furniture member comprises:
   a plurality of slide-in apertures that are positioned on an end of a side of the second furniture member;

wherein the slide-in apertures, can be elongated oval shaped, the slide-in apertures each comprising an entry opening, which connects to an entry interior, and a target opening, which connects to a target interior, such that the entry and target interiors are connected along an elongated direction;

such that the first furniture member is attachable to the second furniture member by inserting each of the plurality of slide-in dowels through a corresponding entry aperture, such that each dowel reaches into the corresponding entry interior of a corresponding slide-in aperture, and then push the first furniture member sideways, in direction of and parallel to a lateral axis of the slide-in aperture, such that the slide-in dowels each slide from the corresponding entry interior into a corresponding target interior, such that the dowels are each securely held in place inside a corresponding target interior;

whereby, the first furniture member is securely attached to the second furniture member.

In a related aspect, a slide-in aperture, can be manufactured according to a method of manufacturing an elongated slide-in aperture, by
a) Inserting a slide-in drill bit vertically into the second furniture member, thereby creating an entry interior; and
b) Moving the slide-in drill bit horizontally, thereby creating a target interior.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a slide-in fastening system prior to assembly, according to an embodiment of the invention.

FIG. 2 is a perspective view of a slide-in fastening system after assembly, according to an embodiment of the invention.

FIG. 3A is a front top perspective view of a slide-in dowel of the slide-in fastening system, according to an embodiment of the invention.

FIG. 3B is a front top perspective view of a slide-in dowel of the slide-in fastening system, according to an embodiment of the invention.

FIG. 4A is a side view of a slide-in dowel of the slide-in fastening system, according to an embodiment of the invention.

FIG. 4B is a side view of a slide-in dowel of the slide-in fastening system, according to an embodiment of the invention.

FIG. 4C is a front view of a slide-in dowel of the slide-in fastening system, according to an embodiment of the invention.

FIG. 4D is a front view of a slide-in dowel of the slide-in fastening system, according to an embodiment of the invention.

FIG. 5A is a front view of a slide-in aperture of the slide-in fastening system, according to an embodiment of the invention.

FIG. 5B is a side view of a slide-in aperture of the slide-in fastening system, according to an embodiment of the invention.

FIG. 5C is a perspective view of a slide-in aperture of the slide-in fastening system, according to an embodiment of the invention.

FIG. 5D is a perspective view of a slide-in aperture of the slide-in fastening system with a slide-in dowel inserted, according to an embodiment of the invention.

FIG. 6A is a side view showing manufacturing of a slide-in aperture of the slide-in fastening system, according to an embodiment of the invention.

FIG. 6B is a side view showing manufacturing of a slide-in aperture of the slide-in fastening system, according to an embodiment of the invention.

FIG. 6C is a side view showing manufacturing of a slide-in aperture of the slide-in fastening system, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

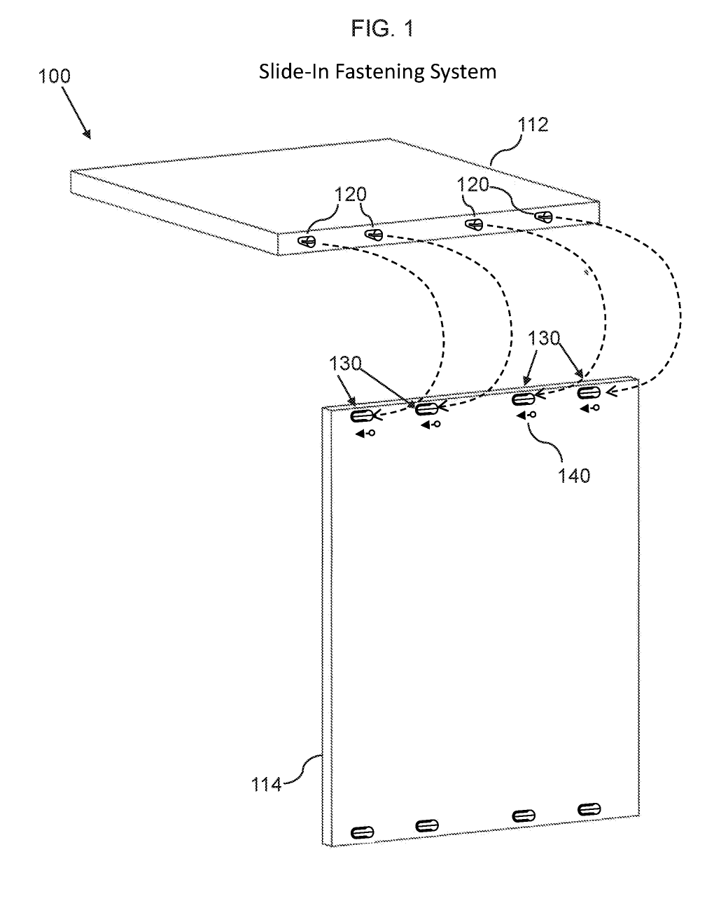

In the following, we describe the structure of an embodiment of a slide-in fastening system 100 for assembly of cabinets and other furniture with reference to FIG. 1, in such manner that like reference numerals refer to like components throughout; a convention that we shall employ for the remainder of this specification.

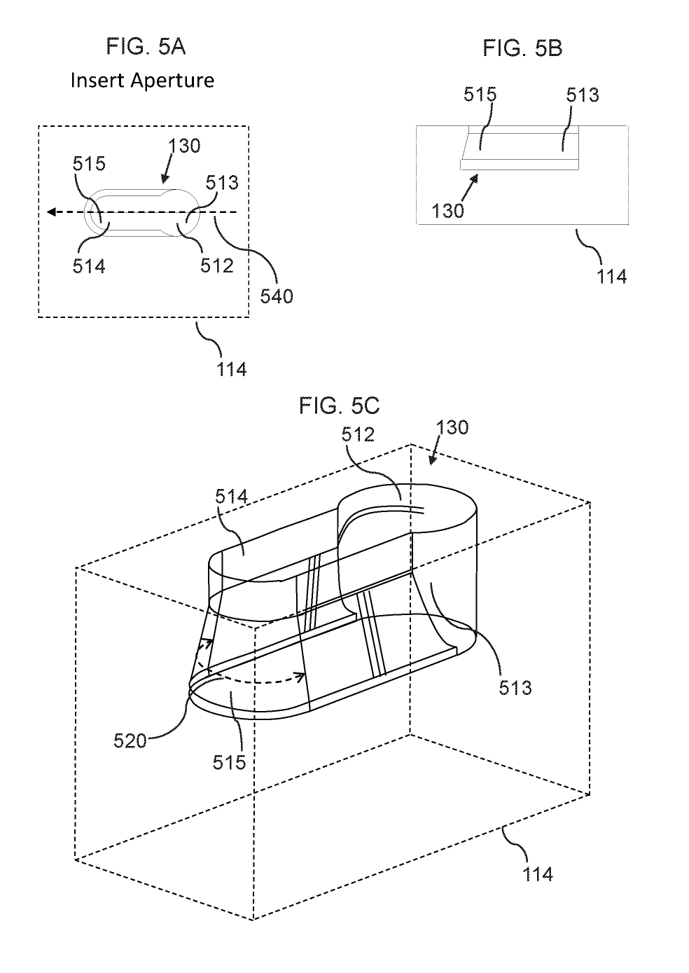

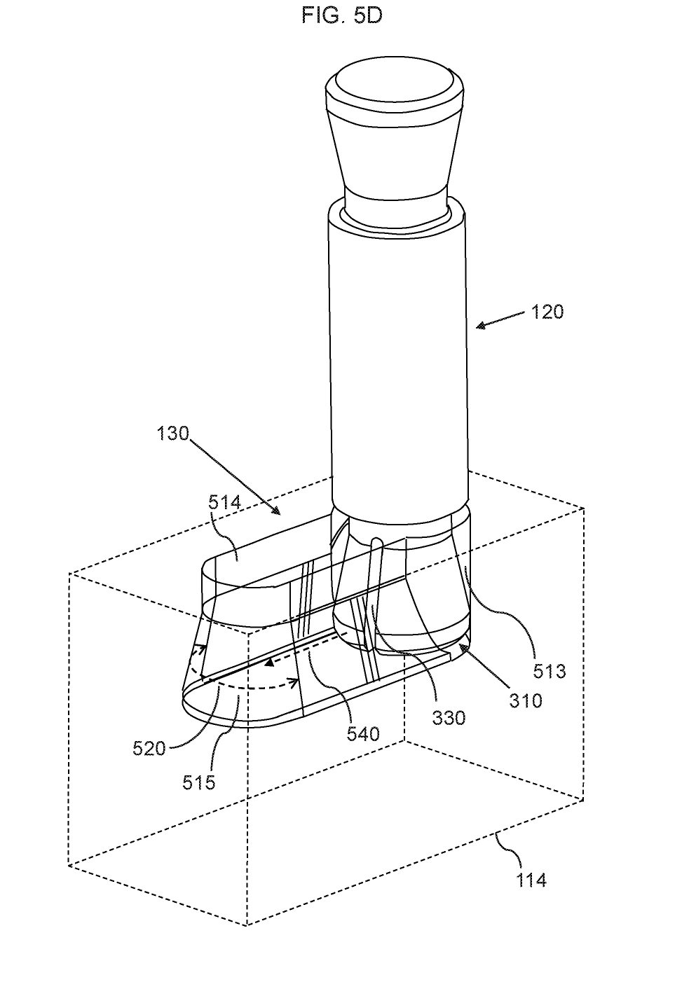

In an embodiment, a system for slide-in fastening 100 can include:
a) A first furniture member 112, which can be a first cabinet piece 112, such as a horizontal cabinet top/bottom 112, wherein the first furniture member 112 comprises:
   a plurality of slide-in dowels 120 protruding from an end of the first furniture member; and
b) A second furniture member 114, which can be a second cabinet piece 114, such as a vertical cabinet side 114, wherein the second furniture member 114 comprises:
   a plurality of slide-in apertures 130 that are positioned on an end of a side of the second furniture member 114;

wherein the slide-in apertures 130, as shown in FIGS. 5A, 5B, and 5C can be elongated keyhole shaped, the slide-in apertures 130 each comprising a first opening 512, also called an entry opening 512, which connects to a first interior 513, also called an entry interior 513, and a second opening 514, also called a target opening 514, which connects to a second interior 515, also called a target interior 515, such that the entry and target interiors 513 515 are connected to form a combined interior 513 515 along an elongated direction 540 of the slide-in aperture 130 (and similarly the entry and target opening 512 514 are connected to form a combined opening 512 514 along the elongated direction 540);

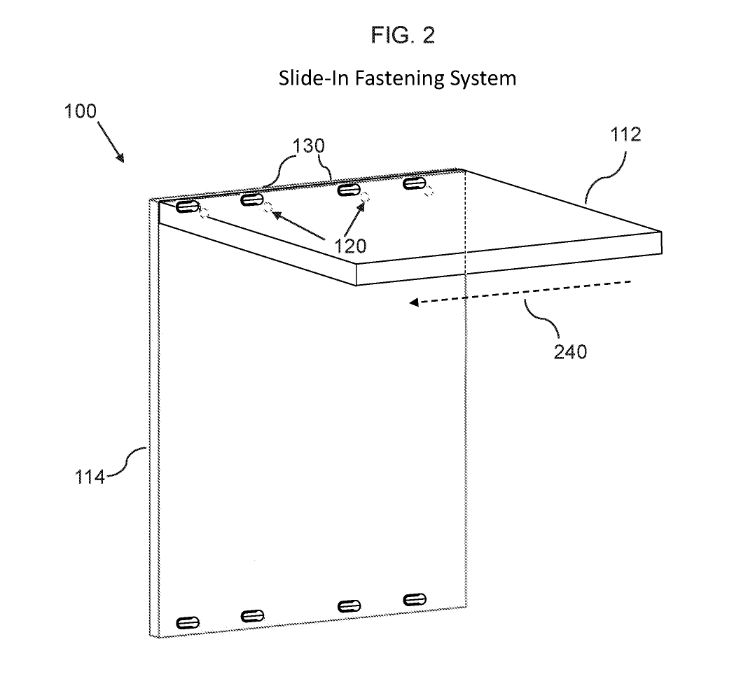

such that the first furniture member 112 is attachable to the second furniture member 114 by inserting each of the plurality of slide-in dowels 120 through a corresponding entry aperture 512, such that each dowel 120 reaches into the corresponding entry interior 513 of a corresponding slide-in aperture 130, and then push the first furniture member 112 sideways 140 240, in direction of and parallel to a lateral axis 540 of the slide-in aperture 130, as shown in FIGS. 1 and 2, such that the slide-in dowels 120 each slide from the corresponding entry interior 513 into a corresponding target interior 515, such that the dowels 120 are each securely held in place inside a corresponding target interior 515;

whereby, as shown in FIG. 2, the first furniture member 112 is securely attached to the second furniture member 114.

A slide-in dowel 120, can also be referred to as a bugle-head dowel 120, due to the bugle/funnel shaped configuration of the front cutout 310.

In related embodiments, glue can be injected into the target interiors 515 prior to sliding the slide-in dowels 120 into the target interiors 515.

In related embodiments, the first and second furniture members 112 114 can be perpendicularly connected, such as shown in FIG. 2.

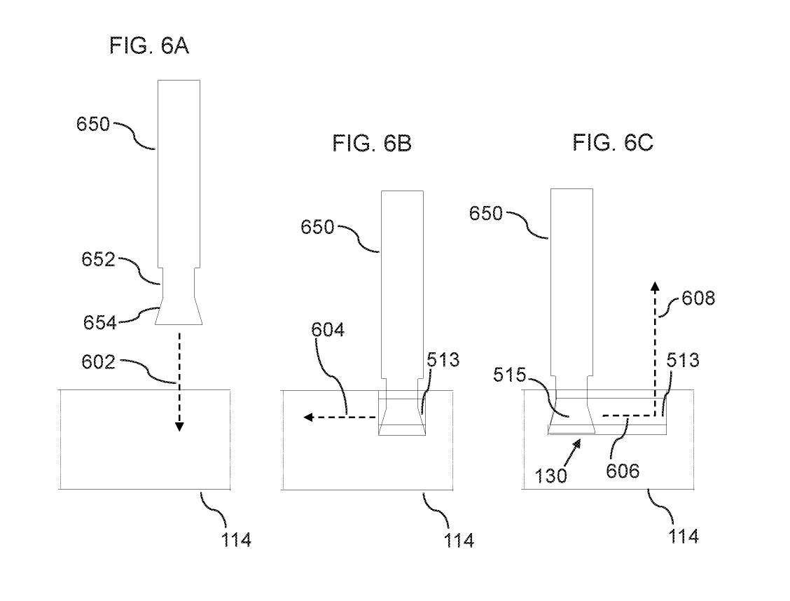

In related embodiments, the slide-in apertures 130, as shown in FIG. 6A, 6B, and 6C can be manufactured according to a method of manufacturing an elongated slide-in aperture 130, by
a) Inserting a slide-in drill bit 650 vertically 602 into a substrate 114, which can be a second furniture member 114, as shown in FIG. 6A, thereby creating an entry interior 513, as shown in FIG. 6B;
b) Moving the slide-in drill bit 650 horizontally 604, thereby creating a target interior 515, as shown in FIG. 6C and 5C; and
c) Retracting the slide-in drill bit 650, including:
   i. First, retracting horizontally 606, and
   ii. Secondly, retracting vertically 608;

wherein a lower end of the slide-in drill bit 650 is rotationally symmetric and shaped as an outer end of a slide-in dowels 120, the lower end of the slide-in drill bit 650, comprising a cylindrical cutting section 652 connected to an outer bugle-shaped cutting section 654;

such that the cylindrical cutting section 652 and the outer bugle-shaped cutting section create the target interior 515, when the slide-in drill bit 650 is moved horizontally 604.

In further related embodiments, vertical movement 602 may in most manufacturing environments be configured via a vertical movement of a drilling machine with the slide-in drill bit 650 attached, but can alternatively be configured with a stationary drill bit 650 and vertical movement of the substrate 114. Horizontal movement 604 may in most manufacturing environments be configured with a stationary drill bit 650 and horizontal movement of the substrate 114, but can also be done via a horizontal movement of a drilling machine with the slide-in drill bit 650 attached.

In a related embodiment, as shown in FIGS. 3A and 3B, a slide-in dowel 120 can be configured as a cylindrical member, which is rotationally symmetric around an elongated center axis 350 of the slide-in dowel 120, the slide-in dowel 120 including a first front cutout 310, including:
a) a cutout surface 312, which cuts at an angle so that the slide-in dowel 120 narrows from a front 346 of the cutout surface 312 to a rear 348 of the cutout surface 312;
b) an entry cut 314, which is a front cut that connects with a front of the cutout surface 312, such that the entry cut 314 is configured to ease insertion of the slide-in dowel 120; and
c) a rear cut 316, which connects with a rear of the cutout surface 312 to reach the rear/center surface 340 of the slide-in dowel 120.

In a further related embodiment, as shown in as shown in FIG. 3B, the entry cut 314 can be connected with the front of the cutout surface 312 via a first cylindrical cut 313.

In a further related embodiment, as shown in as shown in FIG. 3B, the rear of the cutout surface 312 can be connected to the rear cut 316 via a second cylindrical cut 311.

In a related embodiment, the slide-in dowel 120 can further include a second front cutout 310, positioned in an opposing end of the slide-in dowel 120, which allows the slide-in dowel to be inserted with either end into a slide-in aperture 130. This can be useful during automated manufacturing, since an automated insertion machine may not be able to reliably determine or establish axial orientation of the slide-in dowel 120 prior to insertion into a slide-in aperture 130.

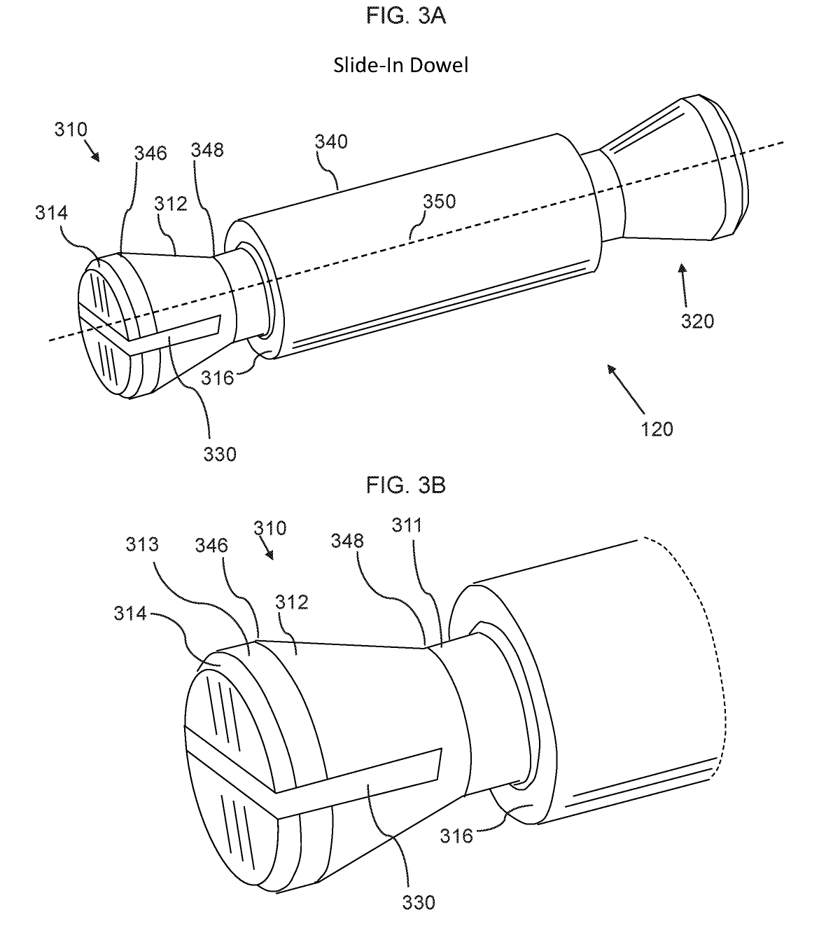

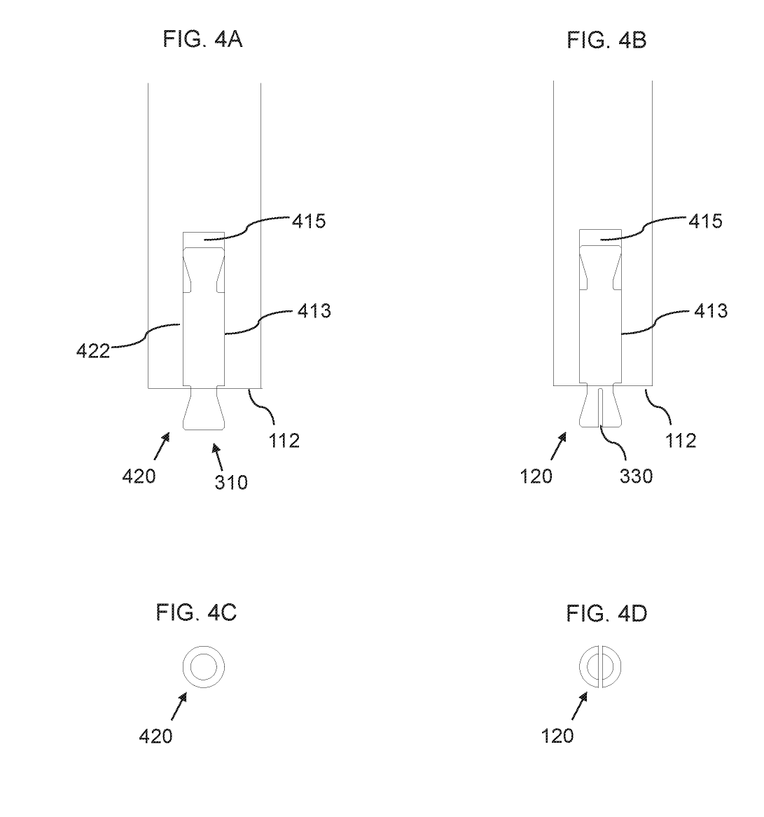

In a related embodiment, as shown in FIG. 4A, an inner end 422 a slide-in dowel 420 without a compression slit 330 can be permanently connected to the first furniture member 112, by insertion of the inner end 422 into a predrilled aperture 413 of the first furniture member 112, with a glue pocket/deposit 415 inserted in a bottom of the predrilled aperture.

In a related embodiment, as shown in FIGS. 3A, 3B, and 4B, the exposed outer end of the slide-in dowel 420 can further include a compression slit 330, to form a slide-in dowel 120, such that the compression slit 330 is configured to allow the slide-in dowel 120 to be compressible when it is slid into the target interior 515. FIGS. 4C and 4D show front views of the respective slide-in dowels 420 120.

In a related embodiment, as shown in FIGS. 3A, 3B, and 5A-5D, the shape of the target interior 515 can be configured to match with the shape of a front end of a slide-in dowel 120 with front cutout 310, such that when the slide-in dowel 120 is pushed horizontally 540 from the entry interior 513 into the target interior 515, as shown in FIG. 5D, the slide-in dowel 120 will be pulled inwards to reach the matching shape of the target interior, such that the shape of the front cutout 310 pulls the slide-in dowel 120 inwards to minimize compression, whereby the slide-in dowel 120 is securely and tightly connected in the target interior 515. The inward pull of a plurality of slide-in dowels 120 will thereby ensure that the first and second furniture members 112 114 are pulled tightly and securely together, as shown in FIG. 2.

In a further related embodiment, as shown in FIGS. 5C and 5D, the target interior 515 can be configured with a size that matches the slide-in dowels 120, such that the slide-in dowel 120 contracts/compresses slightly when the slide-in dowels 120 is pushed into the target interior 515, due to compression of the slide-in slit 330, whereby the slide-in dowel 120 is tightly secured inside the slide-in aperture 130. The slide-in dowel 120 will be in contact with inner edges of the slide-in aperture 130, throughout an outer 180-degree semi-cone 520 at an outer end of the slide-in aperture 130, wherein the outer 180-degree semi-cone 520 is formed during manufacturing by an outer periphery of the rotating slide-in drill bit 650.

In a related embodiment, as shown in FIG. 4A and 4B, a method of manufacturing a slide-in dowel 120, can comprise:
a) Inserting a slide-in dowel 420 into a furniture member 112, wherein the slide-in dowel 420 can for example be made of injection molded plastic, and manufactured without a compression slit 330, such that the slide-in dowel 420 is glued into a predrilled aperture, as shown in FIG. 4A; and
b) Machining the exposed front cutout 310 of the dowel 420, to create a compression slit 330 in the front cutout 310, for example using a cutting or grinding tool, such that the dowel 420 is transformed to a slide-in dowel 120, as shown in FIG. 4B, such that the compression slit 330 is parallel to the lateral axis 540 when the slide-in dowel 120 is inserted into the slide-in aperture 130.

Here has thus been described a multitude of embodiments of the system for slide-in fastening 100, including devices and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A system for slide-in fastening, comprising:
a) a first furniture member, comprising:
a plurality of slide-in dowels protruding from an end of the first furniture member; and
b) a second furniture member, comprising:
a plurality of slide-in apertures, which are positioned on an end of a side of the second furniture member;
wherein the plurality of slide-in apertures each comprise an entry opening, which connects to an entry interior, and a target opening, which connects to a target interior, such that the entry and target interiors are connected to form a combined interior along an elongated direction of each slide-in aperture; and
such that the first furniture member is configured to be attachable to the second furniture member by inserting each of the plurality of slide-in dowels through a corresponding entry aperture, such that a corresponding slide-in dowel reaches into a corresponding entry interior of a corresponding slide-in aperture, and then push the first furniture member sideways, in direction of and parallel to a lateral axis of the slide-in aperture, such that the corresponding slide-in dowel slides from the corresponding entry interior into a corresponding target interior, such that the corresponding slide-in dowel is securely held in place inside the corresponding target interior;
whereby the first furniture member is securely attached to the second furniture member.

2. The system for slide-in fastening of claim 1, wherein the first furniture member further comprises:
predrilled apertures with glue deposits in bottoms of the predrilled apertures; wherein inner ends of the slide-in dowels each are permanently connected to the first furniture member, by insertion of the inner ends into the predrilled apertures with the glue deposits.

3. The system for slide-in fastening of claim 1, wherein the first and second furniture members are perpendicularly connected.

4. The system for slide-in fastening of claim 1, wherein the corresponding slide-in dowel is configured as a cylindrical member, which is rotationally symmetric around an elongated center axis of the slide-in dowel, the corresponding slide-in dowel further comprising a first front cutout, which is positioned in a first end of the corresponding slide-in dowel, the first front cutout comprising:
a first cutout surface, which is configured to be funnel-shaped, such that the slide-in dowel narrows from a front of the first cutout surface to a rear of the first cutout surface.

5. The system for slide-in fastening of claim 4, wherein the first front cutout further comprises:
a) an entry cut, which is a front cut that connects with a front of the first cutout surface, such that the entry cut is configured to ease insertion of the corresponding slide-in dowel; and
b) a rear cut, which connects with a rear of the first cutout surface to reach a center surface of the corresponding slide-in dowel.

6. The system for slide-in fastening of claim 4, wherein the first end of the corresponding slide-in dowel further comprises a compression slit, such that the compression slit is configured to allow the corresponding slide-in dowel to be compressible when it is slid into the corresponding target interior.

7. The system for slide-in fastening of claim 4, wherein the slide-in dowel further comprises a second front cutout, which is positioned in a second end of the slide-in dowel, the second front cutout comprising:
a second cutout surface, which is configured to be funnel-shaped, such that the slide-in dowel narrows from a front of the second cutout surface to a rear of the second cutout surface.

8. The system for slide-in fastening of claim 4, wherein the corresponding target interior is configured with a size that matches the corresponding slide-in dowel, such that the corresponding slide-in dowel contracts when the corresponding slide-in dowel is pushed into the corresponding target interior, due to compression of the slide-in slit, such that the corresponding slide-in dowel is tightly secured inside the corresponding slide-in aperture.

9. A method of manufacturing a slide-in dowel, comprising:
a) inserting the slide-in dowel into a predrilled aperture of a furniture member, wherein the predrilled aperture is filled with a glue; and
b) machining an exposed first front cutout of the slide-in dowel, to create a compression slit in the exposed front cutout;
wherein the slide-in dowel is configured as a cylindrical member, which is rotationally symmetric around an elongated center axis of the slide-in dowel, the slide-in dowel further comprising the exposed first front cutout, which is positioned in a first end of the slide-in dowel, the exposed first front cutout comprising:
a first cutout surface, which is configured to be funnel-shaped, such that the slide-in dowel narrows from a front of the first cutout surface to a rear of the first cutout surface.

10. The method of manufacturing a slide-in dowel of claim 9, wherein the exposed first front cutout further comprises:
a) an entry cut, which is a front cut that connects with a front of the first cutout surface, such that the entry cut is configured to ease insertion of the slide-in dowel; and
b) a rear cut, which connects with a rear of the first cutout surface to reach the rear/center surface of the slide-in dowel.

11. The method of manufacturing a slide-in dowel of claim 9, wherein the slide-in dowel further comprises a second front cutout, which is positioned in a second end of the slide-in dowel, the second front cutout comprising:
a second cutout surface, which is configured to be funnel-shaped, such that the slide-in dowel narrows from a front of the second cutout surface to a rear of the second cutout surface.

12. A system for slide-in fastening, comprising:
a plurality of slide-in dowels, which are configured to protrude from an end of a first furniture member, such that the plurality of slide-in dowels are configured to connect with a plurality of slide-in apertures, which are positioned on an end of a side of a second furniture member, wherein the plurality of slide-in apertures each comprise an entry opening, which connects to an entry interior, and a target opening, which connects to a target interior, such that the entry and target interiors are connected to form a combined interior along an elongated direction of each slide-in aperture; and
such that the first furniture member is configured to be attachable to the second furniture member by inserting each of the plurality of slide-in dowels through a corresponding entry aperture, such that a corresponding slide-in dowel reaches into a corresponding entry interior of a corresponding slide-in aperture, and then push the first furniture member sideways, in direction of and parallel to a lateral axis of the slide-in aperture, such that the corresponding slide-in dowel slides from the corresponding entry interior into a corresponding target interior, such that the corresponding slide-in dowel is securely held in place inside the corresponding target interior;
whereby the first furniture member is securely attached to the second furniture member.

13. The system for slide-in fastening of claim 12, wherein the corresponding slide-in dowel is configured as a cylindrical member, which is rotationally symmetric around an elongated center axis of the slide-in dowel, the corresponding slide-in dowel further comprising a first front cutout, which is positioned in a first end of the corresponding slide-in dowel, the first front cutout comprising:
a first cutout surface, which is configured to be funnel-shaped, such that the slide-in dowel narrows from a front of the first cutout surface to a rear of the first cutout surface.

14. The system for slide-in fastening of claim 13, wherein the first front cutout further comprises:
a) an entry cut, which is a front cut that connects with a front of the first cutout surface, such that the entry cut is configured to ease insertion of the corresponding slide-in dowel; and
b) a rear cut, which connects with a rear of the first cutout surface to reach a center surface of the corresponding slide-in dowel.

15. The system for slide-in fastening of claim 13, wherein the first end of the corresponding slide-in dowel further comprises a compression slit, such that the compression slit is configured to allow the corresponding slide-in dowel to be compressible when it is slid into the corresponding target interior.

16. The system for slide-in fastening of claim 13, wherein the slide-in dowel further comprises a second front cutout, which is positioned in a second end of the slide-in dowel, the second front cutout comprising:
a second cutout surface, which is configured to be funnel-shaped, such that the slide-in dowel narrows from a front of the second cutout surface to a rear of the second cutout surface.
